(19) United States
(12) Patent Application Publication
(10) Pub. No.: US 2007/0188038 A1
(43) Pub. Date: Aug. 16, 2007

(54) SELF MAGNETIZING MOTOR

(75) Inventors: Sung-Ho LEE, Anyang (KR); Jae-Hak CHOI, Seoul (KR); Jae-Min KIM, Seoul (KR)

Correspondence Address: GREENBLUM & BERNSTEIN, P.L.C., 1950 ROLAND CLARKE PLACE, RESTON, VA, 20191, US

(73) Assignee: LG ELECTRONICS INC., Seoul (KR)

(21) Appl. No.: 11/608,584

(22) Filed: Dec. 8, 2006

(30) Foreign Application Priority Data
Feb. 10, 2006 (KR) 10-2006-0013278

(51) Int. Cl. H02K 17/00; H02K 19/00; H02K 1/00

(52) U.S. Cl. 310/159; 310/216; 310/162; 310/166; 310/DIG. 2

(57) ABSTRACT

A self magnetizing motor is disclosed, which comprises a stator which is comprised of a plurality of sheets including a plurality of stator slots and exciter slots formed at fixed intervals along an outer circumferential surface of the center, a teeth provided between each of the stator slots, and an exciter pole formed between the exciter slots; an exciter coil which is wound on each exciter slot; and a rotor which is rotatably inserted into the center (C) of the stator, and is provided with an exciter magnetizable portion on an outer circumferential surface to be magnetized by the exciter coil; wherein the exciter pole is positioned at the part of the stator to form a back yoke of an increased size. Preferably, the exciter pole is positioned at corner of the stator so that a rear stator portion of the exciter pole is increased in size.

### RELATED APPLICATION

The present disclosure relates to subject matter contained in priority Korean Application No. 10-2006-0013278, filed on Feb. 10, 2006, which is herein expressly incorporated by reference in its entirety.

### BACKGROUND OF THE INVENTION

1. Field of the Invention

The present invention relates to a self magnetizing motor, and more particularly, to a self magnetizing motor which improves a magnetizing level of an exciter magnetizing unit.

2. Description of the Background Art

FIG. 1 is an exploded perspective view of illustrating a related art self magnetizing motor, FIG. 2 is a cross section view of illustrating the self magnetizing motor of FIG. 1.

Referring to FIGS. 1 and 2, the related art self magnetizing motor 100 includes a stator 110 which is provided with a plurality of stator slots 111 and exciter slots 112 along an inner circumferential surface at fixed intervals, a teeth 113 provided between each of the stator slots 111, and an exciter pole 114 provided between each of the exciter slots 112; a main-coil 120 which is wound on each stator slot 111; a sub-coil 130 which is wound on each stator slot 111, wherein a current phase of the sub-coil 130 is prior to a current phase of the main-coil 120 by 90°; an exciter coil 140 which is wound on the exciter slot 112; and a rotor 160 which is rotatably inserted into the center (C) of the stator 110, and is provided with an exciter magnetizable portion 150 on an outer circumferential surface to be magnetized by the exciter coil 140.

As the exciter magnetizable portion 150 is provided on the outer circumferential surface of the rotor 160, and the exciter pole 114 is provided in the stator 110 to selectively magnetize the exciter magnetizable portion 150, the self magnetizing motor is operated by an induced electromotive force generated by the main-coil 120, the sub-coil 130 and a conductor bar 161 of the rotor 160 from an initial operation right before a synchronous speed. On the synchronous speed, the self magnetizing motor is operated by an induced electromotive force generated by the exciter pole 114 and the exciter magnetizable portion 150.

In the meantime, a magnetizing level of the exciter magnetizable portion 150 has large effects on an operation efficiency of the self magnetizing motor 100 on the synchronous speed. To improve the magnetizing level of the exciter magnetizing portion 150, the following methods may be be used.

Firstly, the magnetizing intensity is improved by increasing the turns of the exciter coil 140. Secondly, the magnetizing current is increased by increasing the diameter of the exciter coil 140. Thirdly, the magnetizing intensity is improved by increasing the turns of the exciter coil 140, and the magnetizing current is increased by increasing the diameter of the exciter coil 140. Fourthly, the exciter magnetizable portion 150 is formed of the material which has the good magnetizing property. However, the firstly proposed method has a problem in that a current is decreased in a predetermined-voltage state. Thus, the magnetizing intensity may be constant without being increased, so that it is not effective due to the restriction of space and the increased cost. Also, the secondly proposed method has the restriction of space. The thirdly proposed method may have the saturated magnetic induction. The fourthly proposed method has the increased cost.

### SUMMARY OF THE INVENTION

Therefore, an object of the present invention is to provide a self magnetizing motor which improves a magnetizing level of an exciter magnetizing unit by changing a position of an exciter pole.

To achieve these and other advantages and in accordance with the purpose of the present invention, as embodied and broadly described herein, there is a self magnetizing motor comprising a stator which is comprised of a plurality of sheets including a plurality of stator slots and exciter slots formed at fixed intervals along an outer circumferential surface of the center, a teeth provided between each of the stator slots, and an exciter pole formed between the exciter slots; an exciter coil which is wound on each exciter slot; and a rotor which is rotatably inserted into the center (C) of the stator, and is provided with an exciter magnetizable portion on an outer circumferential surface to be magnetized by the exciter coil; wherein the exciter pole is positioned at the part of the stator to form a back yoke of an increased size. Preferably, the exciter pole is positioned at an corner of the stator so that a rear stator portion of the exciter pole is increased in size.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exploded perspective view illustrating a related art self magnetizing motor;

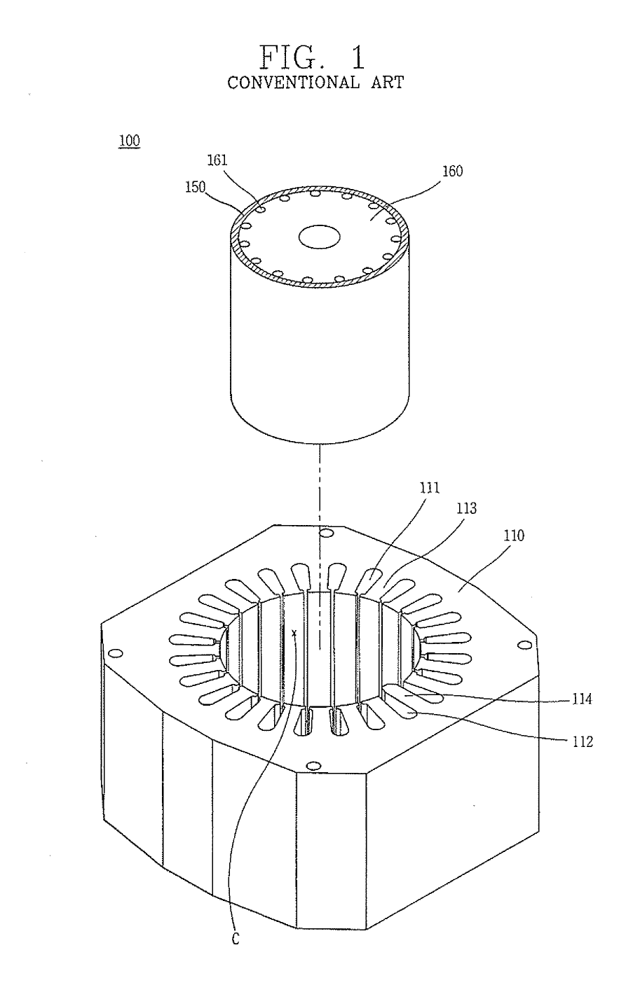

FIG. 2 is a cross sectional view illustrating the self magnetizing motor shown in FIG. 1;

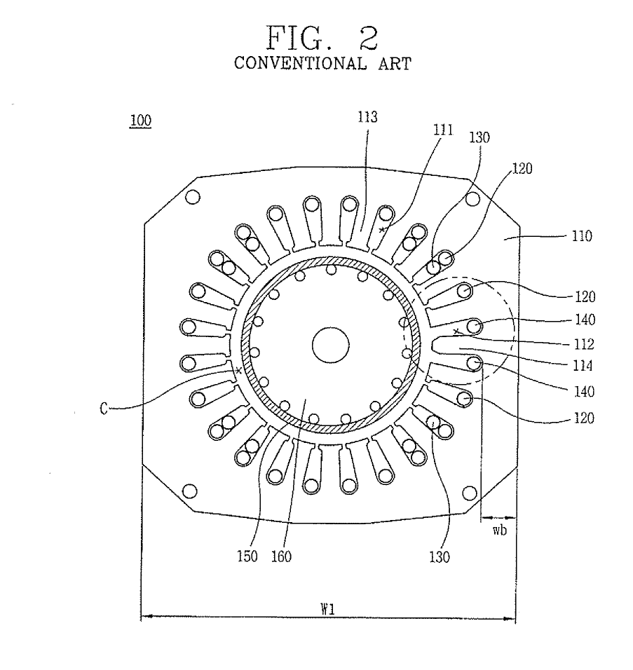

FIG. 3 is a cross sectional view illustrating a self magnetizing motor according to one preferred embodiment of the present invention; and

FIG. 4 is an expanded view illustrating ‘A’ of FIG. 3.

### DETAILED DESCRIPTION OF THE INVENTION

Reference will now be made in detail to the preferred embodiments of the present invention, examples of which are illustrated in the accompanying drawings.

Hereinafter, a self magnetizing motor according to the present invention will be explained with reference to the accompanying drawings.

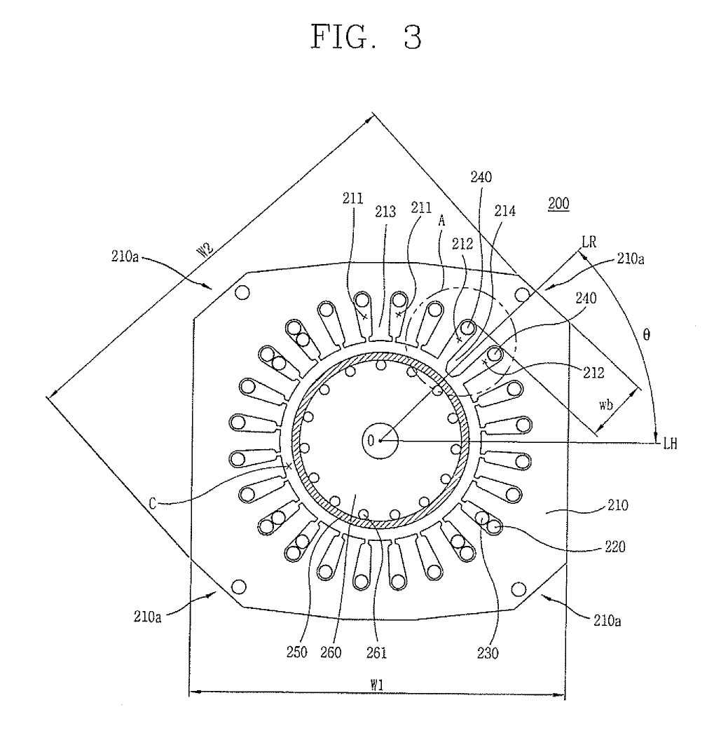

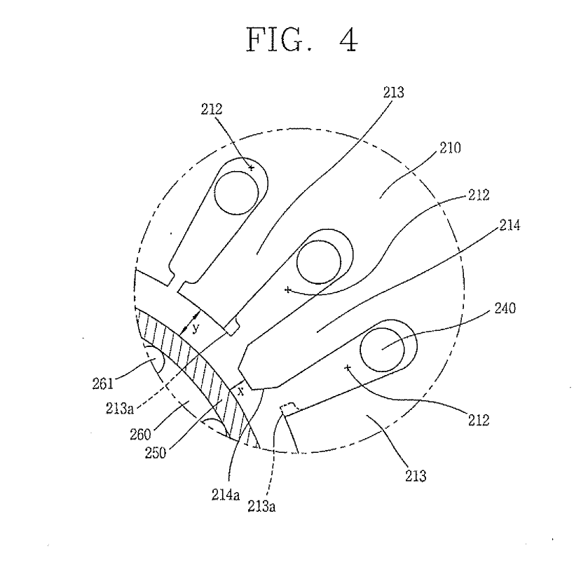

FIG. 3 is a cross sectional view illustrating a self magnetizing motor according to one preferred embodiment of the present invention. FIG. 4 is an expanded view of illustrating ‘A’ of FIG. 3.

Referring to FIGS. 3 and 4, the self magnetizing motor 200 according to one preferred embodiment of the present invention includes a stator 210 which has a plurality of sheets provided with a plurality of stator slots 211 and exciter slots 212 along an inner circumferential surface of the center (c) at fixed intervals, a teeth 213 provided between each of the stator slots 211, and an exciter pole 214 provided between each of the exciter slots 212, wherein an end of the exciter pole 214 is positioned closer to the center (C) in comparison with an end of the teeth 213; a main-coil 220 which is wound on each stator slot 211; a sub-coil 230 which is wound on each stator slot 211, wherein a current phase of the sub-coil 230 is prior to a current phase of the main-coil 220 by 90°; an exciter coil 240 which is wound on the exciter slot 212; and a rotor 260 which is rotatably inserted into the center (C) of the stator 210, and is provided with an exciter magnetizable portion 250 on an outer circumferential surface to be magnetized by the exciter coil 240.

The exciter pole 214 is positioned at an corner 210a of the stator 210 so that a rear stator portion 210 (hereinafter, referred to as a back yoke) of the exciter pole 214 is increased in size.

At this time, the corner 210a of the stator 210 is positioned on a rotation line (LR) which is obtained as rotating the central point (O) of the stator 210 by 45°, 135°, 225°, and 315° counter clockwise with respect to a horizontal line (LH). Accordingly, the exciter pole 214 may be positioned on any one rotation line (LR) which is obtained by rotating the central point (O) of the center (C) at any one angle (θ) of 45°, 135°, 225°, and 315° counter clockwise with respect to the horizontal line (LH) passing through the central point (O) of the center (C). In this preferred embodiment, the exciter pole 214 is positioned on the rotation line (LR) which is obtained as counter clockwise rotating the central point (O) of the stator 210 by 45° with respect to the horizontal line (LH).

As described above, since the exciter pole 214 is positioned at the corner 210a of the stator 210, it is unnecessary to increase a width (Wb) of the back yoke of the exciter pole 214 by increasing a width (W1) of the stator 210. In case of the related art, it necessarily requires increasing the width (W1) of the stator 210 SO as to increase the size of the back yoke. In the present invention, the position of the exciter pole 214 is moved to the corner 210a of the stator 210 which has the large width (W2) of the diagonal direction. Thus, the width (Wb) of the back yoke is increased without the process of increasing the width (W1) of the stator 210. Accordingly, the magnetizing level of the self magnetizable portion 250 is improved without the increase of cost and the size restriction for the self magnetizing motor.

To improve the magnetizing level of the exciter magnetizable portion 250, a gap (x) between the end of the exciter pole 214 and the outer circumferential surface of the exciter magnetizable portion 250 is smaller than a gap (y) between the end of the teeth 213 and the outer circumferential surface of the excite magnetizable portion 250. At this time, the magnetic permeability of air is 1/3000 times smaller than the magnetic permeability of exciter pole 214, whereby it has the large magnetic resistance. Generally, the intensity of magnetic field is in proportion to the current I is in proportion to the turns; and is in inverse proportion to the magnetic resistance R. In this respect, as the gap (x) between the end of the exciter pole 214 and the outer circumferential surface of the exciter magnetizable portion 250 becomes smaller, the intensity of magnetic field becomes increased by (y/x), thereby improving the magnetizing level of the exciter magnetizable portion 250.

Among the plurality of teeth 213, the teeth 213 which are close to the exciter slot 212 have the structure of removing some portions (pole shoe) 213a of the end thereof so as to prevent the magnetic flux generated by the exciter coil 140 from being leaked.

Also, there is a tapered portion 214a in the end of the exciter pole 214 to thereby prevent the magnetic flux generated by the exciter coil 240 from being leaked.

The exciter magnetizable portion 250 may be formed of a magnetizable material which can be selectively magnetized by the current flowing in the exciter coil 240 wound on the exciter pole 214, that is, a material which is easily magnetized or demagnetized.

The exciter magnetizable portion 250 is formed of an additional body being separated from the rotor 260, and is fixed to the outer circumferential surface of the rotor 260, wherein the exciter magnetizable portion 250 is formed in a cylindrical structure. Also, the exciter magnetizable portion 250 of a layered-type may be coated on the outer circumferential surface of the rotor 260.

An operation of the above self magnetizing motor according to the present invention will be explained as follows.

Referring to FIGS. 3 and 4, as the external AC current is applied to the main-coil 220 and the sub-coil 230 wound on the stator slot 211 on the initial operation of the self magnetizing motor, wherein current phase of the sub-coil 230 is prior to the current phase of the main-coil 220 by 90°, the rotating magnetic field is formed in the stator 210.

As the induced current flows in a conductor bar 261 of the rotor 260 by the rotating magnetic field, the rotor 260 is rotated by the induced current.

When the rotor 260 is slipped and rotated after the operation, the current of the sub-coil 230 is cut-off by a current breaker (not shown), and the current flows only in the main-coil 220.

As the rotor 260 rotates, the exciter magnetizable portion 260 positioned in the outer circumferential surface of the rotor 260 is magnetized at a low density by the rotating magnetic field of the stator 210, that is, the hysteresis effects. Eventually, the rotor 260 is rotated by the hysteresis torque of the hysteresis effects and the induced torque of above-mentioned induced current.

In the meantime, if the current is applied to the exciter coil 240 in a state that the rotation speed of the rotor 260 is about 2,520-2,880 rpm corresponding to 70-80% of the synchronous speed of the rotating magnetic field in the stator 210, the magnetic flux generated by the exciter coil 240 is transmitted to the exciter magnetizable portion 250, whereby the exciter magnetizable portion 250 is magnetized at a high density. At this time, since the exciter pole 240 is positioned at the corner 210a of the stator 210, it is possible to improve the magnetizing level of the exciter magnetizable portion 250. Also, some portions (pole shoe) 213a of the end of the teeth 213 being positioned close to the exciter slot 212 are removed, and the tapered portion 214a is formed in the end of the exciter pole 214. Thus, the magnetic flux generated by the exciter coil 240 is not leaked, thereby improving the magnetizing level of the exciter magnetizable portion 250.

As the exciter magnetizable portion 250 is magnetized at the high density, the rotor 260 is rotated at the synchronous speed of the rotating magnetic field without slipping. At this time, the induced current is not flowing in the conductor bar 261. That is, the rotor 260 is operated by the magnetomotive force generated by the exciter pole 214 and the exciter magnetizable portion 250.

As mentioned above, the self magnetizing motor according to the present invention has the following advantages.

First, the exciter pole is positioned at the corner of the stator, whereby it is possible to improve the magnetizing level of the exciter magnetizable portion without increasing the size of the self magnetizing motor, thereby improving the magnetizing efficiency and decreasing the fabrication cost.

Secondly, the gap between the end of the exciter pole and the outer circumferential surface of the exciter magnetizable portion is smaller than the gap (y) between the end of the teeth and the outer circumferential surface of the excite magnetizable portion. Thus, the efficiency of the self magnetizing motor is improved with the increased magnetizing level of the exciter magnetizable portion.

Thirdly, some portions of the end of the teeth being positioned close to the exciter slot are removed, and the tapered portion is formed in the end of the exciter pole, whereby the magnetizing level of the exciter magnetizable portion is improved by preventing the magnetic flux generated by the exciter coil from leaking, thereby improving the efficiency of self magnetizing motor.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A self magnetizing motor comprising:
a stator which is provided with a plurality of sheets including a plurality of stator slots formed at fixed intervals along an outer circumferential surface of the center, a teeth provided between each of the stator slots, one pair of exciter slots positioned at corners, and an exciter pole formed between the exciter slots; and
a rotor which is rotatably inserted into the center (C) of the stator, and is provided with an exciter magnetizable portion on an outer circumferential surface to be magnetized by the exciter coil.

2. The self magnetizing motor of claim 1, wherein the exciter slots are positioned at both sides on a rotation line (LR) which is obtained as rotating the central point (O) of the center (C) by any one angle of 45°, 135°, 225°, and 315° counter clockwise with respect to a horizontal line (LH) passing through the central point (O) of the center (C).

3. A self magnetizing motor comprising:
a stator which is comprised of a plurality of sheets including a plurality of stator slots and exciter slots formed at fixed intervals along an outer circumferential surface of the center, a teeth provided between each of the stator slots, and an exciter pole formed between the exciter slots;
an exciter coil which is wound on each exciter slot; and
a rotor which is rotatably inserted into the center (C) of the stator, and is provided with an exciter magnetizable portion on an outer circumferential surface to be magnetized by the exciter coil;
wherein the exciter pole is positioned at the part of the stator to form a back yoke of an increased size.

4. The self magnetizing motor of claim 3, wherein the exciter pole is positioned on a rotation line (LR) which is obtained as rotating the central point (O) of the center (C) by any one angle of 45°, 135°, 225°, and 315° counter clockwise with respect to a horizontal line (LH) passing through the central point (O) of the center (C).

5. The self magnetizing motor of claim 3, wherein a gap (x) between the end of the exciter pole and the outer circumferential surface of the exciter magnetizable portion is smaller than a gap (y) between the end of the teeth and the outer circumferential surface of the excite magnetizable portion.

6. The self magnetizing motor of claim 3, wherein some portions of the end of the teeth being positioned close to the exciter slot are removed, and a tapered portion is formed in the end of the exciter pole.

7. A self magnetizing motor comprising:
a stator which is provided with a plurality of sheets including a plurality of stator slots formed at fixed intervals along an outer circumferential surface of the center, a teeth provided between each of the stator slots, one pair of exciter slots positioned at corners, and an exciter pole formed between the exciter slots; and
a rotor which is rotatably inserted into the center (C) of the stator, and is provided with an exciter magnetizable portion on an outer circumferential surface to be magnetized by the exciter coil,
wherein a gap (x) between the end of the exciter pole and the outer circumferential surface of the exciter magnetizable portion is smaller than a gap (y) between the end of the teeth and the outer circumferential surface of the excite magnetizable portion, some portions of the end of the teeth being positioned close to the exciter slot are removed, and a tapered portion is formed in the end of the exciter pole.

8. The self magnetizing motor of claim 7, wherein the exciter slot is positioned on a rotation line (LR) which is obtained as rotating the central point (O) of the center (C) by any one angle of 45°, 135°, 225°, and 315° counter clockwise with respect to a horizontal line (LH) passing through the central point (O) of the center (C).
